(19) United States
(12) Patent Application Publication
(10) Pub. No.: US 2018/0114187 A1
(43) Pub. Date: Apr. 26, 2018

(54) PRINTABLE MEDIA DISTRIBUTION SYSTEM AND METHOD

(71) Applicant: PINPUT LLC, Gilbert, AZ (US)

(72) Inventors: Christopher A DENGLER, Queen Creek, AZ (US); Cameron J. NORMOYLE, Gilbert, AZ (US)

(21) Appl. No.: 15/690,173

(22) Filed: Aug. 29, 2017

Related U.S. Application Data
(60) Provisional application No. 62/380,601, filed on Aug. 29, 2016.

(51) Int. Cl. G06Q 10/08; G06Q 50/16

(52) U.S. Cl. CPC G06Q 10/0875; G06Q 2250/70; G06Q 2250/90; G06Q 50/16

(57) ABSTRACT

Systems and methods of the present invention are directed to processing details from a given record of inventory, or other data, and automatically creating printable media. A new template, a previously saved template, or a customized template can be used to create the desired layout and content for printing. Content imported into the templates can be edited by the user.

### PRIORITY

This application claims priority to and the benefit of U.S. Provisional Patent Application No. 62/380,601, filed Aug. 29, 2016, which is fully incorporated herein by reference.

### TECHNICAL FIELD

The present invention relates generally to systems, methods, and computer programs for obtaining data from a data source to automatically create printable media.

### BACKGROUND OF THE INVENTION

Inventory in areas such as real estate is frequently changing, whether it be new property additions, price changes, detail updates, and the like. Current systems require a user to conduct a search of listings, review and sort the results, and then print out or otherwise direct the results to specific output devices—in a predefined and non-customizable format. Undesirably, the end user is required to proactively conduct the searches, sorting, design, layout, and outputting actions.

Accordingly, there exists a need for new, improved, and more efficient systems and methods for automatically creating printable media from data sources, such as property inventory and other items of interest.

### SUMMARY OF THE INVENTION

Particular embodiments of the present invention are directed to the automatic creation of printable media from inventory or other information in a data source. The present invention makes it possible for individuals or businesses to tie inventory, products, or general items of interest in a data store to printable media creation tools.

It is desirable to take inventory stored in a database and create printable media, based upon many factors associated with the data—e.g., a new home for sale on the market, a new line of products at a music store, a specific color of an automobile on a car lot, etc. It is also advantageous to be able to create printable media based upon this data. The present invention is adapted to process the details from a given record of inventory and automatically create printable media based upon either a new template, a previously saved or default template, or via a customized template—inserting the obtained data from the data store into fields or other available areas of the printable media template.

The above and other aspects and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIGS. 1-2 show exemplary hardware architecture and software functionality configurations, in accordance with embodiments of the present invention.

FIG. 3 shows data query, processing, and output printing methods and steps, in accordance with embodiments of the present invention.

### DETAILED DESCRIPTION

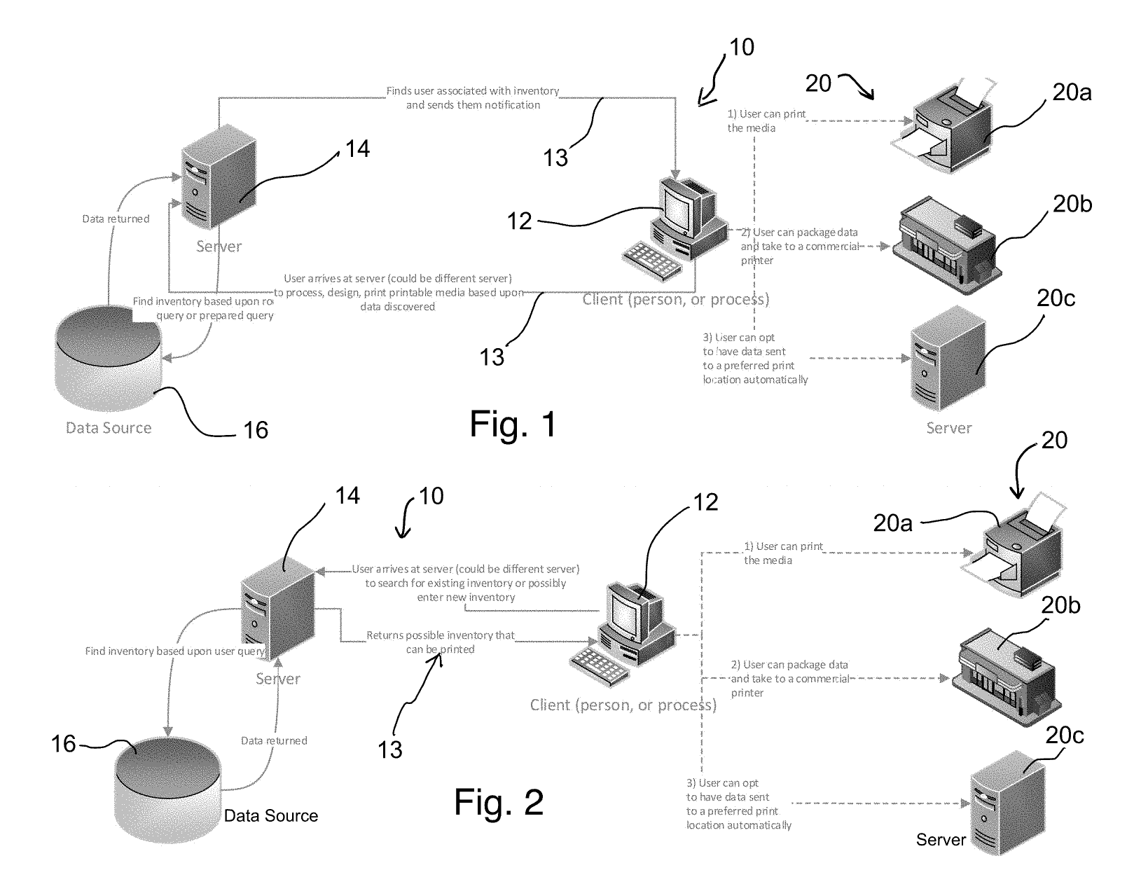

Referring generally to FIGS. 1-3, exemplary methods, and computer programs, or software application systems 100 are adapted to read and process data from a data source to automatically create printable media. New, existing, or customizable templates can be utilized to create and define the style, format, and overall output of the printable media. Content imported into the templates can be edited by the user.

FIGS. 1 and 2 show exemplary embodiments of architecture arrangements 10 used in providing and processing the software systems 100 of the present invention. For instance, the arrangement 10 can include one or more client devices 12, one or more servers 14, with a network 13 (e.g., the Internet) provided to link the devices 12 and servers 14. One or more data stores 16 (e.g., internal or external) are provided in operative communication with at least the server 14. The data stores 16 can be in the form of an electronic database, web or cloud service, RSS feed, XML file, or a myriad of other known and electronically organized and readable data formats and storage services.

The client device 12 can be operably coupled to or in operable communication with one or more output systems 20, including devices, services, or servers to facilitate or enable printable output. In various embodiments, as shown in FIGS. 1-2, the systems 20 can include a printing device 20a, a commercial printing service 20b, a remote server capable of outputting print media 20c, and the like. The output can be a printable file (e.g., PDF, image, XML, or other file types) that can be printed at the outputs 20a, 20b, 20c, etc. Other output methods, services, or systems capable of receiving (manually or automatically) the printable data are also envisioned for use without deviating from the spirit and scope of the present invention.

FIG. 1 depicts an architecture scheme 10 including a data store 16 and server 14 in communication with a client device 12 such that the server 14 or software of the system 100 processes data and locates the applicable client user associated with inventory or data within the data source 16 and sends a notification to the user of data ready for printable output. The user can communicate with the server 14 to process, design, and print the media based upon the discovered data—e.g., prepared or processed automatically at the server 14, or prepared and processed by the client user on the server 14.

FIG. 2 shows an embodiment of the architecture 10 wherein the user, via the client device 12, communicates or operatively logs in to, or otherwise interacts with, the server 14 to search for existing inventory or other items of interest, or to enter new inventory or data. The server 14 processes this information to find inventory based upon the user query within the data source 16. The server 14 processes, initially formats, and returns or communicates the processed inventory data to the client device 12 that can then be printed, automatically or as directed by the user—e.g., by the user via one or more of the printing devices or services 20. Again, the data can be outputted to one or more files for download (e.g., a PDF, image, or other file type) such that the user can simply download the files and print them from a printer at the user device 12, or via any of the devices or services 20.

Other hardware and software configurations for carrying out the disclosed methods and processes can be implemented without deviating from the spirit and scope of the present invention.

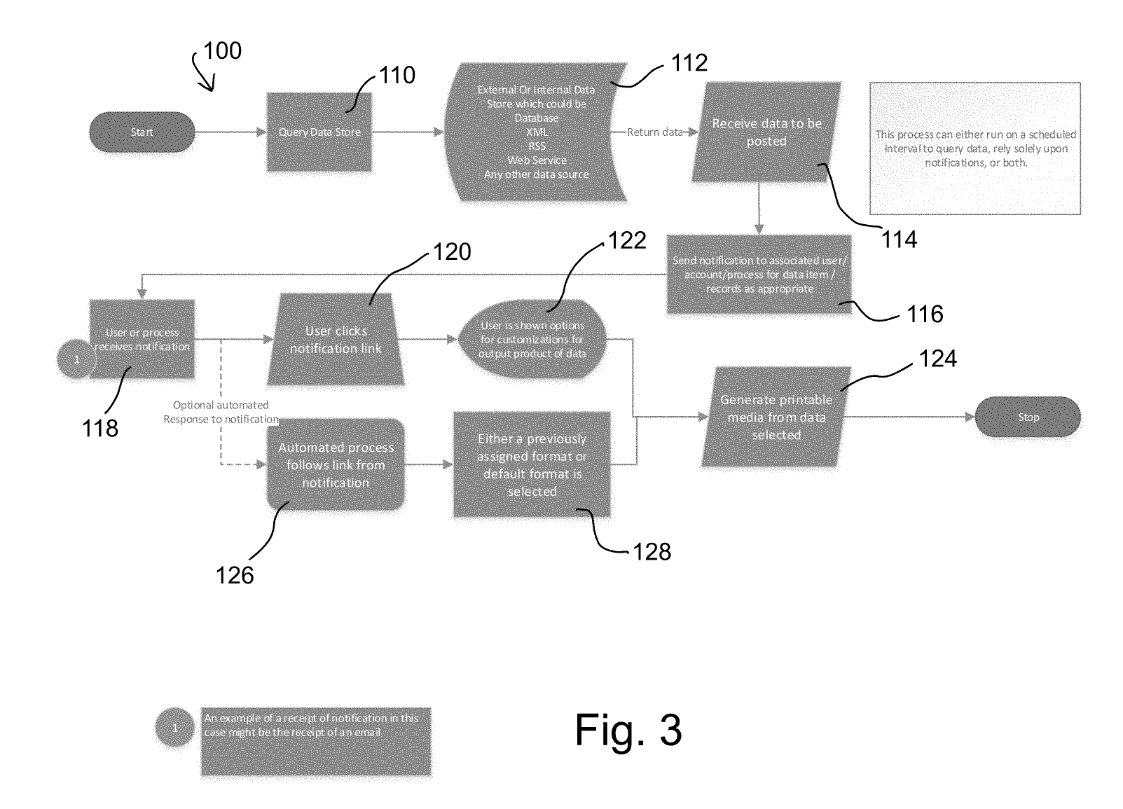

Referring to FIG. 3, exemplary method steps of the present invention are detailed. The system 100 queries data at step 110 from external or internal data stores, such as an electronic database, XML files, RSS feeds, web or cloud services, or other available data formats and sources (step 112). The queries described herein can occur on scheduled intervals (seconds, minutes, hours, days, etc.), triggered based on a notification, trigger based on user initiated and controlled queries, or rely on both scheduled and notification processes. The queried data is then received, or received and processed, for posting, sending, or communicating at step 114. The system 100 can then send a notification (e.g., electronically) to an associated user, account, or process as appropriate and determined by the system or user device at step 116.

Next, the user or process can receive the notification (step 118), which can be in the form of a link in an email in certain embodiments (other electronic forms of notifications are envisioned in other embodiments). When the user selects (e.g., clicks on the link or otherwise indicates or inputs a selection) the notification link at step 120, the options are displayed to the user on the client device 12 that permit the user to review and customize the output format or data product for the queried data (step 122). In other embodiments, an automated process takes place, wherein software processes the notification to automatically select and follow the link (step 126), at the user device or one or more servers, and assign a format, or a default format, for outputting of the data to print media (step 128). In either the user-initiated or automated processes, printable media is generated at step 124 from the data queried, processed, or selected in the previous processes and steps. For instance, the system 100 can electronically insert or input the obtained data from the data store into fields or other available or designated areas of the electronic printable media template for printing. As detailed herein, the media can be outputted to various devices, files, services, or systems 20. The disclosed processes and methods of the system 100 can be run on a scheduled interval to query data, rely on notifications, or use scheduled and notification methods.

The following is an example of the systems and processes of the present invention used to obtain and process inventory stored in a database to create printable media. This exemplary embodiment is directed to real estate data from a known data source (e.g., in conjunction with the one or more servers 14, or included in a third-party database such as a real estate “MLS” database, etc.). It is noted that this is just an example of the present invention in use and is not intended in any way to limit the application to any particular field, areas of commerce, commercial products or services, data types, etc. Other applications and data examples can include retail store inventory (product, price, features, etc.), vehicle inventory, commercial services and services data, and a myriad of other areas, fields, and possibilities.

In this example, a real estate agent or other user may have a new property listing with a specific address, or have criteria for locating general or specific new or existing listings. For instance, the data source 16 can be queried in many different ways (automatically by the system 100, based on user inputs, or a combination thereof) including selections of all newly listed homes listed by that individual as of a certain date, selections of any homes in a specific price range within a certain distance or within a certain zip code, selections of any listed homes with a particular broker, and like criteria. The listing data can be searched or queried by the user, or inputted into the data store by the user—e.g., a listing database.

Each query can contain a list of n number of real estate listings, and each listing can contain one or more photos and other information/data about the property or product. An example listing might include the title/address of the property, photos of the property, the listing date, a description of the property (e.g., school district, neighborhood, square feet, bathrooms, etc.), and the like. While this example is a single real estate record contained within the queried search, several, dozens, or more of such records can be included and processed for eventual printing.

Continuing with this exemplary embodiment, the data store 16 has a query stored within it that can be processed and can include all homes newly listed on the market as of a specific day, or range of days, by comparisons, etc. The system 100 then notifies the user that they have listed a new home, or other product, within the available inventory; or can notify the user that listings are available or have been recently listed or added (e.g., comparable or uniquely tagged or filtered properties based on specific data). Again, the notification could be in the form of an email, an SMS/Text, an internet-based message, etc., and the sending of the notification as well as the receipt process for receiving the notification can be automated, with processing and automatic or scheduled inputs and outputs.

The user in this example will receive an email or SMS that invites them to select or click on a link to an application, website, service, etc. The user can then see the details of the listing, or listings, on the user device, and can select an existing print format (e.g., layout and content), create a new format, or customize an existing format. The details (test, data, photos, etc.) are processed and inserted into or otherwise provided in a printable format or template based on the default, selected, or modified layout. Once complete, the user can save the file or data to the device 12 for further processing, and can attend to printing of the file or data. Further, certain embodiments will automatically direct the printable file or media to a printing device or service, as disclosed herein, for automatic printing. As shown in FIGS. 1-2, the file or data can also be sent (e.g., via email/message, through the server, or manually) to a printing store, or to a server, to facilitate printing. In various embodiments, a login option can be provided for the user after they select the notification link, before the user begins manipulation of the data or formatting.

The present invention makes it possible for individuals and businesses to tie their inventory, products, or general items of interest in a data store/source to permit and enable the user to obtain or create printable media representative of the product, including the user's desired branding/information and other printable template layouts and data/display formats.

Various devices or computing systems can be included and adapted to process and carry out the aspects, computations, and algorithmic processing of the systems 100 of the present invention. Computing systems and devices of the present invention may include a processor, which may include one or more microprocessors and/or one or more circuits, such as an application specific integrated circuit (ASIC), field-programmable gate arrays (FPGAs), etc. Further, the devices can include a network interface. The network interface is configured to enable communication with the network 13, other devices and systems, and servers, using a wired and/or wireless connection.

The devices or computing systems may include memory, such as non-transitive memory, which may include one or more non-volatile storage devices and/or one or more volatile storage devices (e.g., random access memory (RAM)). In instances where the devices include a microprocessor, computer readable program code may be stored in a computer readable medium or memory, such as, but not limited to magnetic media (e.g., a hard disk), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The computing devices 12 may include an input device. The input device is configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices 12 can also include an output device. Examples of output devices include monitors, televisions, mobile device screens, tablet screens, speakers, remote screens, etc. The output device can be configured to display images, media files, text, or video, or play audio to a user through speaker output.

Server processing systems 14, for use or connected with the systems 100 of the present invention, can include one or more microprocessors, and/or one or more circuits, such as an application specific integrated circuit (ASIC), field-programmable gate arrays (FPGAs), etc. A network interface can be configured to enable communication with the network 13, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to magnetic media (e.g., a hard disk), optical media (e.g., a DVD), memory devices, etc.

The present invention can be embodied as software code residing on a user's computing device 12 (e.g., desktop, tablet, mobile, and the like) and/or on the server 14. The various data of the present invention can be included on and transferred to and from a storage area network (SAN), a data cloud, or any computing device for storing the file or files being uploaded, downloaded, or processed.

Aspects of the software code of the invention can take the form of a plugin or app, and can interface with various protocols or software using APIs or other means of interacting with computing software and systems.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. A method for automatically providing printable media output, comprising:
providing a data store adapted for reading from and writing to an item database;
providing a server in operable communication with the at least one data store;
querying data from the item database;
sending an electronic notification to a user including the at least one selectable link;
operatively selecting the at least one selectable link;
generate printable media including the queried data; and
printing the printable media based on a defined layout.

2. The method of claim 1, wherein operatively selecting the at least one selectable link is automatically facilitated by the server or a user device.

3. The method of claim 1, wherein the item database includes real estate inventory data.

4. The method of claim 1, wherein the printable media includes text and one or more images.

5. The method of claim 4, wherein the printable media is formatted with a predefined layout for the text or the one or more images.

6. The method of claim 4, wherein the user can modify the layout of the text or the one or more images, at a user device or the server.

7. The method of claim 1, wherein the user can select from a plurality of templates for presenting the printable media.

8. The method of claim 1, further including automatically printing the printable media at a device in operative communication with a user device.

9. The method of claim 1, wherein the user facilities printing of the printable media.

10. The method of claim 1, wherein sending the electronic notification includes sending of the electronic notification via SMS or email.

11. A system to automatically providing printable media output, comprising:
a processor;
a non-transitory memory operatively coupled to the processor;
a data store adapted for reading from and writing to an item database, wherein the processor is configured to:
query data from the item database;
send an electronic notification to a user including at least one selectable link;
generate printable medical included the queried data; and
formatting the printable medical based on the queried data.

12. The system of claim 11, wherein the processor further schedules a time for sending the electronic notification.

13. The system of claim 11, wherein the data store is internal to one or more servers.

14. The system of claim 11, wherein the data store is remote to one or more servers.

15. The system of claim 11, wherein the at least one selectable link is automatically selected by the processor or a user device.

16. The system of claim 11, wherein the data store includes real estate inventory data.

17. The system of claim 11, wherein the printable media includes text and one or more images.

18. The system of claim 11, wherein the user can modify the format of the text or the one or more images.

19. The system of claim 11, wherein the user can select from a plurality of templates for presenting the printable media in one or more layouts.

20. The system of claim 11, wherein the printable media is automatically printed at a device in operative communication with a user device.
